(19) United States
(12) Patent Application Publication
(10) Pub. No.: US 2013/0171369 A1
(43) Pub. Date: Jul. 4, 2013

(54) METHOD FOR MANUFACTURING ELECTRODE PATTERN OF DISPOSABLE ELECTROCHEMICAL SENSOR STRIP

(71) Applicant: Wen Wang, New Taipei City (TW)

(72) Inventor: Wen Wang, New Taipei City (TW)

(73) Assignee: Brilliant Sensing Technology Co., Ltd., New Taipei City (TW)

(21) Appl. No.: 13/342,136

(22) Filed: Jan. 2, 2012

(51) Int. Cl. B05D 5/12

(52) U.S. Cl. 427/535; 427/123; 427/533; 427/125

(57) ABSTRACT

Disclosed is a method for manufacturing an electrode pattern of a disposable electrochemical sensor strip. The method comprises steps of preparing a nonconductive substrate; forming a mask film with an inverse pattern on at least one side of the nonconductive substrate, said mask film is made of water soluble material or solvent soluble material; forming a metal film both on the mask film and the nonconductive substrate; and washing out, by water, solvent, or water solution, the mask film and the metal film which is on the mask film, so as to form a metal electrode with the electrode pattern on at least one side of the substrate of the disposable electrochemical sensor strip.

### FIELD OF THE INVENTION

The present invention relates to a method for manufacturing an electrochemical sensor strip, and more particularly to a method for manufacturing an electrode pattern of a disposable electrochemical sensor strip which is suitable for examining an analyte in a fluid sample, for example, the concentration of glucose in human blood, and the concentration of a uric acid.

### BACKGROUND OF THE INVENTION

Generally, a utilization of a noble metal as an electrode material for an electrochemical sensor can achieve a high stability and a high reproducibility of detection and is ready a well-known technique in the field of electrochemistry. It needs to use the photolithography and etching processes of thin film technology in order to produce the electrochemical sensors. As a result, the cost of the electrochemical sensor with noble metal electrodes is high.

The principle of electrochemical sensor has been developed and applied in detecting all kinds of fluid biochemical ingredient. An electrochemical sensor may have different configurations for conforming to different functions. For example, a conventional electrochemical sensor may include a chemical reagent and a plurality of testing electrodes.

The chemical reagent is used for chemically reacting with an analyte contained in the fluid sample and generating an output signal with an electric parameter, wherein the electric parameter is corresponding to a biochemical ingredient of the analyte contained in the fluid sample. For example, if the fluid sample is human blood and the analyte is glucose, the chemical reagent is basically a glucose oxidase or a complex thereof.

The testing electrodes such as a counter electrode, a working electrode, and a reference electrode are used for transmitting a working voltage for an electrochemical reaction from an electrochemical meter to the electrochemical strip and again transmitting the electric parameter to the electrochemical meter after the analyte contained in the fluid sample undergoes an electrochemical reaction so that the electrochemical meter can process a numerical analysis and then display the result thereon.

Meanwhile, the testing electrodes can only include the counter electrode and the working electrode or further include a reference electrode. Moreover, a detecting electrode could be included as a fourth electrode. The number of the plural testing electrodes is varied according to the requirement of the electrochemical reaction.

The electrodes of different functions are made of different materials. In the laboratory, the counter electrode is made of any conductive material, however the lower the conductive resistance the better the effect.

The selection of the working electrode is more complex and can be sorted as two types, one is an electron-transfer mediator modified working electrode and the other is a metal-catalyzed electrode. The electron-transfer mediator modified working electrode has a chemical reagent immobilized thereon, wherein the chemical reagent includes an enzyme (such as a glucose oxidase) and a redox mediator (such as a potassium ferricyanide which is extensively used in the glucose testing piece). The enzyme and the analyte will react with each other to produce a new chemical compound (such as H202), the electrons generated from the redox reaction between the mediator and H202 is utilized to produce an electric signal, and through the electrode, the electric parameter can be outputted. The main purpose of this kind of electrode is only simply a conductor and is not involved in chemical catalysis. However, the material of the electrode should be selected specifically to avoid a chemical reaction with the fluid sample or the chemical reagent thereby interfering with the result.

The electrode without the chemical interference should be made of an inert conductive material, which is generally a noble metal (such as a gold, a platinum, a palladium, or a rhodium), or a carbon containing material. Furthermore, because carbon and the noble metal have no chemical reactivity at a low temperature, the chemical interference would not happen. However, because the noble metal is more expensive, the carbon made electrode is usually applied as the electron-transfer mediator modified working electrode.

As to the metal-catalyzed electrode, it is made of a material which will directly electrochemically react with the chemical reagent, the analyte, or the derivatives thereof, and has an ability of direct catalysis or a function of a single selectivity for the analyte. Thus, the mediator is not needed to add into the chemical reagent. This kind of electrode, not like the electrode only needs to be made of a chemically inactive metal, is generally made of a material that must have an ability to catalyze the reaction.

The two types of metal electrodes described above both have a high cost of the material and the processes when being formed under a conventional manufacturing method, especially the noble metal. Consequently, although the noble metal has a better stability, it still cannot be the mainstream of the disposable medical treatment testing in family. Nowadays, the biggest requirement of the biosensor is the medical treatment in family for a blood glucose, a uric acid, a cholesterol, etc. And, the electrode used by these biosensors mostly belongs to the electron-transfer mediator modified working electrode, and thus the disposable testing sheet of the biosensor can has the carbon base screen printing electrode printed thereon for educing the cost, as described in U.S. Pat. No. 5,985,116, which is a typical example.

### SUMMARY OF THE INVENTION

It is an object of the present invention to form metal electrodes in a disposable sensor strip for reducing the manufacturing time and saving the manufacturing cost.

The present invention overcomes the drawbacks of the prior art, and provides a method for manufacturing an electrode pattern of a disposable electrochemical sensor strip, comprising steps of: (a) preparing a nonconductive substrate as a substrate of the disposable electrochemical sensor strip; (b) forming a mask film with an inverse pattern on at least one side of the nonconductive substrate, said mask film is made of a water soluble material or a solvent soluble material; (c) forming a metal film both on the mask film and the nonconductive substrate; and (d) washing out, by water, solvent, or water solution, the mask film and the metal film which is on the mask film, so as to form a metal electrode with the electrode pattern on at least one side of the substrate of the disposable electrochemical sensor strip.

In a preferred embodiment of the present invention, in step (a), the nonconductive substrate is made of a material containing PE, PVC, PS, PP, PET, PC, PMMA, PI, polyester, PBT, PVDF, PA, PEN, PES, PAR, water proofed non-woven fiber paper, general water proofed paper, or a combination thereof.

In a preferred embodiment of the present invention, the method further comprises, before step (b), a step of performing a surface pretreatment on the nonconductive substrate.

In a preferred embodiment of the present invention, the surface pretreatment is a treatment performed by applying a primer film on the nonconductive substrate, a corona discharge treatment, a vacuum plasma treatment, an ion beam treatment, or a basic solution soaking treatment.

In a preferred embodiment of the present invention, in step (b), the mask film is formed on the nonconductive substrate by printing, coating, or transferring.

In a preferred embodiment of the present invention, in step (c), the metal film is made of a material selected from a group consisting of gold, platinum, rhodium, palladium, ruthenium, iridium, silver, copper, nickel, titanium, chromium, indium, tin, vanadium, iron, aluminum, beryllium, an oxide thereof, an ahoy thereof, and a combination thereof.

In a preferred embodiment of the present invention, in step (c), the metal film has a thickness in range between 0.005 and 2 μm.

In a preferred embodiment of the present invention, the method further comprises, after step (d), a step of mounting a chemical reagent on a working surface of the metal electrode.

In a preferred embodiment of the present invention, the method further comprises, after step (d), a step of forming a modified film on the metal electrode in which the modified film is formed by processing the metal electrode.

In a preferred embodiment of the present invention, the modified film is an Ag/AgCl film.

With the technique solution provided by the present invention, the time for manufacturing the metal electrode with the electrode pattern on the substrate of the disposable electrochemical sensor strip is shorter than that for a conventional manufacturing method (e.g. photoresist etching) because of eliminating the time in light exposing and etching, reduce the time for washing out the inverse pattern, and so on. Further, because water, solvent, or water solution are used for washing out the mask film, a wastewater discharged during the manufacturing process can have low chemical pollution, and the recycling rate of the wastewater can go up to 90% or more. Thus, it is no needs to spend cost for building recycle apparatus or purification system. Therefore, compared with the conventional manufacturing method, the method of the present invention is high efficient, environmentally friendly, and low costly.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart of a method for manufacturing an electrode pattern of a disposable electrochemical sensor strip of a first embodiment of the present invention;

FIG. 2 is a flow chart of a method for manufacturing an electrode pattern of a disposable electrochemical sensor strip of a second embodiment of the present invention;

FIG. 3 is a flow chart of a method for manufacturing an electrode pattern of a disposable electrochemical sensor strip of a third embodiment of the present invention;

FIG. 4 to FIG. 7 are cross-section views showing a manufacturing process of an embodiment of the present invention;

FIG. 8 is a cross-section view showing a metal electrode on which a chemical reagent is mounted; and

FIG. 9 is a cross-section view showing a metal electrode on which a modified film is formed.

### DETAILED DESCRIPTION OF THE PREFERRED EMBODIMENTS

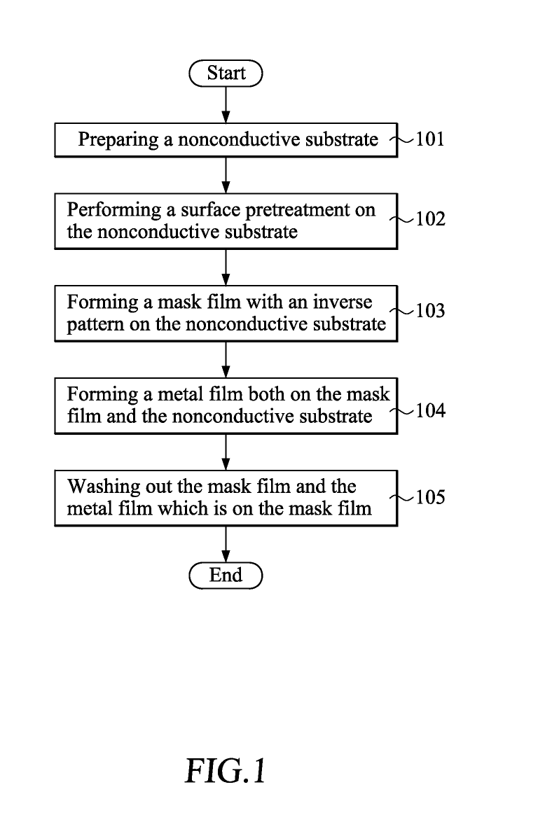

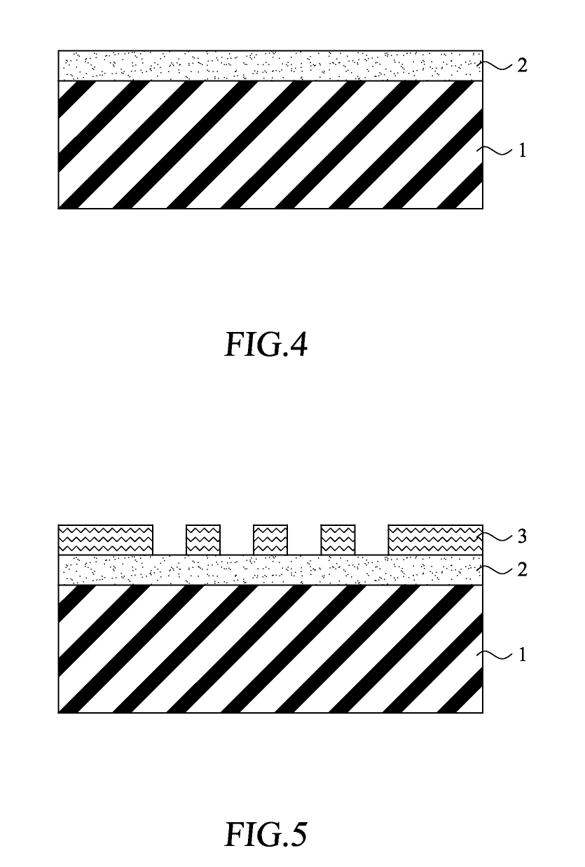

Please refer to FIG. 1, which is a flow chart of a first embodiment of the present invention, together reference made to FIG. 4-7, a description of a method for manufacturing an electrode pattern of a disposable electrochemical sensor strip in accordance with the present invention will be given below.

First, a nonconductive substrate 1 is prepared as a substrate of a disposable electrochemical sensor strip (step 101). The nonconductive substrate 1 is made of a nonconductive material, such as PE, PVC, PS, PP, PET, PC, PMMA, PI, polyester, PBT, PVDF, PA, PEN, PES, PAR, water proofed non-woven fiber paper, general water proofed paper, or a combination thereof. Further, the configuration of the nonconductive substrate 1 may be a plate configuration, a sheet configuration, a film roll configuration, a slab configuration, or the like. And, the transmittance of the nonconductive substrate 1 may provided between 5.0% and 99.5%.

In order to remove oil pollutant and particles which may affect subsequent process, a surface pretreatment may be performed on the nonconductive substrate 1 (step 102). The surface pretreatment may be a corona discharge treatment in which a low temperature corona discharge plasma is used to impart changes in the properties of a surface; a vacuum plasma treatment which is used for etching and surface modification to create porous layers with high reproducibility and for cleaning and surface engineering of plastics, rubbers, and natural fibers as well as for replacing CFCs for cleaning metal components; an on beam treatment in which an on beam is produced to modify and improve the surface qualities of a material by rapidly melting and resolidifying the surface of the material without affecting the underlying material; a basic solution soaking treatment; and the like. Preferably, in this embodiment, the surface pretreatment is performed by applying a primer film 2 on the nonconductive substrate, as shown in FIG. 4.

Next, as shown in FIG. 5, a mask film 3 is formed with an inverse pattern on at least one side of the nonconductive substrate 1 by printing, coating, transferring, or the like (step 103). The mask film 3, which is made of a water soluble material or a solvent soluble material, such as an ink, a dye, a toner, a pigment, an organic polymer, and a colloidal, is soluble in water, solvent, or water solution. In this embodiment, the mask film 3 is only formed on one side of the nonconductive substrate 1. However, the present invention is not limited to this. For example, in the case of manufacturing an electrochemical sensor strip with two-side electrode, the mask film 3 is formed on both sides of the nonconductive substrate 1.

As shown in FIG. 6, after forming the mask film 3 with the inverse pattern, a metal film 4 is formed both on the mask film 3 and the nonconductive substrate 1 (step 104). In a preferred embodiment, the metal film 4 is formed by a sputtering process whereby atoms are ejected from a solid target material due to bombardment of the target by energetic particles. The metal film 4 may made of a material selected from a group consisting of gold, platinum, rhodium, palladium, ruthenium, iridium, silver, copper, nickel, titanium, chromium, indium, tin, vanadium, iron, aluminum, beryllium, an oxide thereof, an alloy thereof, and a combination thereof. And, the metal film 4 has a thickness in range between 0.005 and 20 μm.

Next, by water, solvent, or water solution, the mask film 3 can be washed out, and the metal film 41 which is on the mask film 3 is also removed together with the mask film 3 (step 105). After that, the metal film 42, which is remained on the nonconductive substrate 1, is formed into a metal electrode with the electrode pattern opposite to the inverse pattern. Thus, the metal electrode with the electrode pattern is formed on at least one side of the substrate 1 of the disposable electrochemical sensor strip.

By the method disclosed above, the time for manufacturing the metal electrode with the electrode pattern on the substrate of the disposable electrochemical sensor strip is shorter than that for a conventional manufacturing method (e.g. photoresist etching) because of eliminating the time in photolithography and etching processes, reduce the time for washing out the inverse pattern, and so on. Further, because water, solvent, or water solution are used for washing out the mask film 3, a wastewater discharged during the manufacturing process can have low chemical pollution, and the recycling rate of the wastewater can go up to 90% or more. Thus, it is no needs to spend cost for building recycle apparatus or purification system. Therefore, compared with the conventional manufacturing method, the method of the present invention is high efficient, environmentally friendly, and low costly.

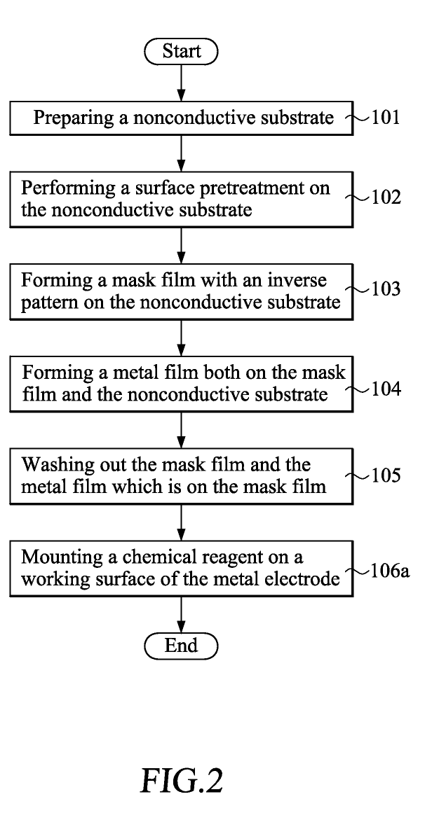

Please refer to FIG. 2, which is a flow chart of a second embodiment of the present invention, together reference made to FIGS. 4-8, a description of a method for manufacturing an electrode pattern of a disposable electrochemical sensor strip in accordance with the present invention will be given below. The same portion as or a portion having a function similar to that described in the first embodiment can be formed in a manner similar to that described in the first embodiment, and also the steps similar to those of the first embodiment can be performed in a manner similar to those described in the first embodiment; therefore, repetitive description is omitted.

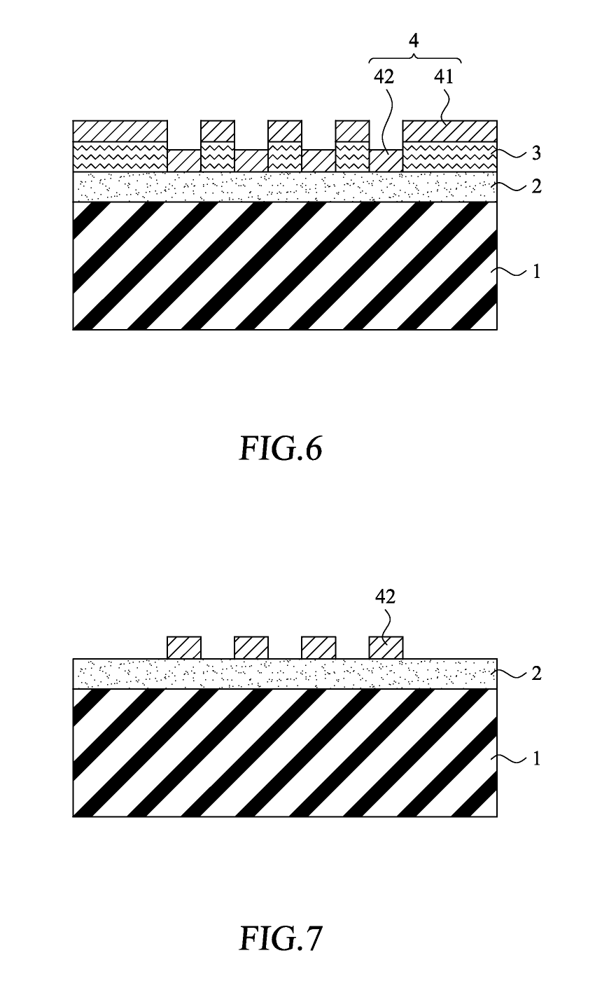

As shown in FIG. 8, in the case that the metal electrode is served as a working electrode such as an electron-transfer mediator modified working electrode or the like, a chemical reagent 5 will be mounted on a working surface of the metal electrode (metal film 42) after forming the metal electrode with the electrode pattern on the substrate of the disposable electrochemical sensor strip (step 106a). Thus, it can detect an analyte through reacting with the analyte contained in a fluid sample, so as to produce a measured signal which is then outputted through a signal output terminal of the metal electrode. In addition, the working electrode and a counter electrode can be formed into an electrode assembly, and a space above the electrode assembly and under the measure region is provided to position therein the chemical reagent 5 with an even thickness.

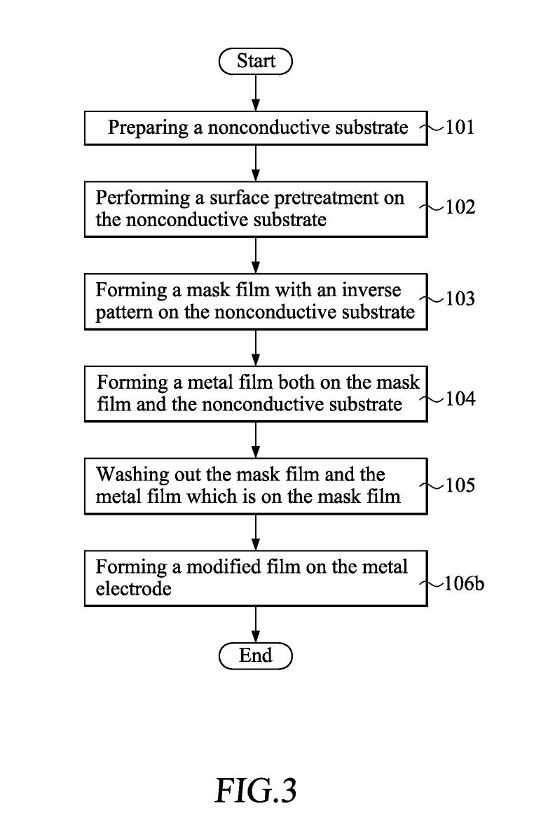

Please refer to FIG. 3, which is a flow chart of a third embodiment of the present invention, together reference made to FIGS. 4-7 and 9, a description of a method for manufacturing an electrode pattern of a disposable electrochemical sensor strip in accordance with the present invention will be given below. The same portion as or a portion having a function similar to that described in the first embodiment can be formed in a manner similar to that described in the first embodiment, and also the steps similar to those of the first embodiment can be performed in a manner similar to those described in the first embodiment; therefore, repetitive description is omitted.

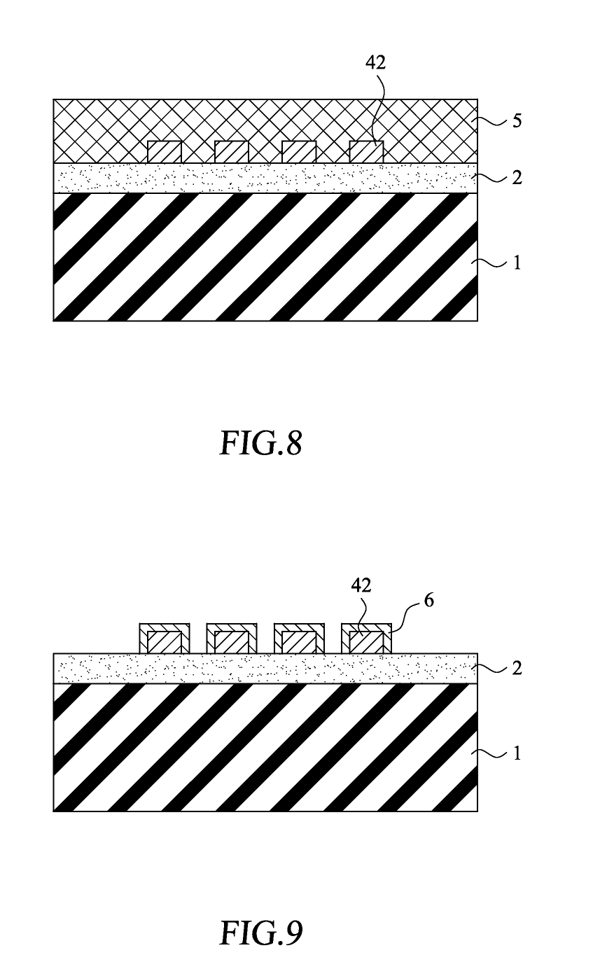

As shown in FIG. 9, in the case that the metal electrode is served as a reference electrode such as a modified electrode or the like, after forming the metal electrode with the electrode pattern on the substrate of the disposable electrochemical sensor strip, a modified film 6 will be formed on the metal electrode (metal film 42) in which the modified film 6 is formed by processing the metal electrode (step 106b). In this embodiment, the modified film 6 is an Ag/AgCl film, the reference electrode is produced by means of printing or electroplating the Ag/AgCl film thereon. The Ag/AgCl film is suitable to be used for the reference electrode because the electric potential thereof is quite stable.

The metal electrode manufactured by the method according to the present invention can be applied in various metal-catalyzed electrodes (not only noble metals) with a direct catalysis, besides in a noble electrode without chemical interference. And, the metal electrode can further be suitable for all kinds of electrochemical detection electrodes, biosensors, fluid biochemical sensor (e.g., sewage, insecticide concentration, and heavy metal sensor strips), domestic medical application (e.g., blood glucose, uric acid, and cholesterol sensor strip).

As can be appreciated from the above embodiments, the method for manufacturing an electrode pattern of a disposable electrochemical sensor strip of the present invention has industry worth which meets the requirement for a patent. The above description should be considered as only the discussion of the preferred embodiments of the present invention. However, a person having ordinary skill in the art may make various modifications to the present invention. Those modifications still fall within the spirit and scope defined by the appended claims.

What is claimed is:

1. A method for manufacturing an electrode pattern of a disposable electrochemical sensor strip, comprising steps of:
(a) preparing a nonconductive substrate as a substrate of the disposable electrochemical sensor strip;
(b) forming a mask film with an inverse pattern on at least one side of the nonconductive substrate, said mask film is made of water soluble material or solvent soluble material;
(c) forming a metal film both on the mask film and the nonconductive substrate; and
(d) washing out, by water, solvent, or water solution, the mask film and the metal film which is on the mask film, so as to form a metal electrode with the electrode pattern on at least one side of the substrate of the disposable electrochemical sensor strip.

2. The method for manufacturing an electrode pattern of a disposable electrochemical sensor strip as claimed in claim 1, wherein in step (a), the nonconductive substrate is made of a material containing PE, PVC, PS, PP, PET, PC, PMMA, PI, polyester, PBT, PVDF, PA, PEN, PES, PAR, water proofed non-woven fiber paper, general water proofed paper, or a combination thereof.

3. The method for manufacturing an electrode pattern of a disposable electrochemical sensor strip as claimed in claim 1 further comprising, before step (b), a step of performing a surface pretreatment on the nonconductive substrate.

4. The method for manufacturing an electrode pattern of a disposable electrochemical sensor strip as claimed in claim 3, wherein the surface pretreatment is a treatment performed by applying a primer film on the nonconductive substrate, a corona discharge treatment, a vacuum plasma treatment, an ion beam treatment, or a basic solution soaking treatment.

5. The method for manufacturing an electrode pattern of a disposable electrochemical sensor strip as claimed in claim 1, wherein in step (b), the mask film is formed on the nonconductive substrate by printing, coating, or transferring.

6. The method for manufacturing an electrode pattern of a disposable electrochemical sensor strip as claimed in claim 1, wherein in step (c), the metal film is made of a material selected from a group consisting of gold, platinum, rhodium, palladium, ruthenium, iridium, silver, copper, nickel, titanium, chromium, indium, tin, vanadium, iron, aluminum, beryllium, an oxide thereof, an alloy thereof, and a combination thereof.

7. The method for manufacturing an electrode pattern of a disposable electrochemical sensor strip as claimed in claim 1, wherein in step (c), the metal film has a thickness in range between 0.005 and 20 μm.

8. The method for manufacturing an electrode pattern of a disposable electrochemical sensor strip as claimed in claim 1 further comprising, after step (d), a step of mounting a chemical reagent on a working surface of the metal electrode.

9. The method for manufacturing an electrode pattern of a disposable electrochemical sensor strip as claimed in claim 1 further comprising, after step (d), a step of forming a modified film on the metal electrode in which the modified film is formed by processing the metal electrode.

10. The method for manufacturing an electrode pattern of a disposable electrochemical sensor strip as claimed in claim 9, wherein the modified film is an Ag/AgCl film.
